(19) United States
(12) Patent Application Publication
(10) Pub. No.: US 2006/0235954 A1
(43) Pub. Date: Oct. 19, 2006

(54) Methods and systems for managing network information objects

(76) Inventor: Aswinikumar Subramanian, Folsom, CA (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/104,849

(22) Filed: Apr. 13, 2005

(51) Int. Cl. G06F 15/173

(52) U.S. Cl. 709/223

(57) ABSTRACT

Methods and systems that substantially reduce the burden of fulfilling network management request response details

### BACKGROUND OF THE INVENTION

Managing and monitoring connected devices is quite important, both for local area network applications and other interconnected environments. Several protocols are known which are designed to enable network management of network attached devices. These protocols often include a collection of objects and procedures for accessing the objects associated with a network attached device. Simple network management protocol (SNMP) is an example of a relatively well known protocol for managing and monitoring network devices.

Under SNMP, a network device has an object management system which includes an object database containing various objects relating to the network device, referred to as a management information base (MIB) and agent software for querying and modifying the objects, referred to as an agent. A system being managed under SNMP also includes a management station running manager software which provides centralized control of the various network devices by communicating with the agent software over the network. The software for management typically runs on a network attached computer and an interface is provided in the form of a graphical user interface. The management software obtains information about the objects in the MIBs of the various network attached devices and allows a user to monitor, query or modify the objects in the MIBs. To monitor, query or modify an object the manager software sends a request over the network to the object management system. Agent software for examining or otherwise performing operations on the object examines the request, and if valid, carries out the request and sends a message back to the manager software. If an agent determines that a request is invalid, for example the request is to write to an object which can only be read, the agent returns the message indicating an error.

In SNMP, the managers software typically obtains information about each network attached device's object management system via a MIB output file. A MIB compiler generates the MIB output file from one or more MIB input files, each of which contains the name of each object in a MIB structure, and the plurality of attributes which describe the objects and the valid operations which can be performed on the objects. The MIB input file reflects the objects and attributes associated with the objects as they were intended to be implemented in the management system. The MIB compiler merges the one or more MIB input files and generates a MIB output file which contains the name of each object in the MIB and the plurality of attributes which describe the objects and the valid operations which can be performed on the objects.

Software products are available that provide an SNMP package which is an API or a library written fully in a software language, such as JAVA. These software products help a user create network management applications that can manage SNMP enabled devices. It can also be used to create SNMP agents. The currently available software products provide a library that is to take care of the SNMP details and provide a graphical interface such that the user can concentrate on the logic of the particular application.

Software products are also available for providing a tool for creating SNMP MIBs and instrumenting agents for the MIBS. The agent builder product provides what can be viewed as a SNMP to any gateway where the any stands for any back-end protocol. The back-end protocol could include for example file read and write operations, performing system commands, executing code and proxying to other SNMP agents.

However, representing the MIB structure as lists of object instantiations and values, finding a relationship between two objects in each of two lists requires parsing through the first list to find the first object and parsing through the second list to find the objects in the second list related to the objects in the first list. The parsing and searching adds an additional burden to the management application.

There is a need to provide methods and systems that substantially reduce the burden of fulfilling network management (such low-level SNMP requests) request response details.

### BRIEF SUMMARY OF THE INVENTION

One embodiment of the system of this invention includes one or more processors, one or more computer usable media comprising a description, stored in the one or more computer usable media, of a number of network information objects, the description comprising a descriptive name for each network information object, one or more correlation instructions describing at least one relationship between the network information objects, the one or more correlation instructions being expressed in terms of the description of at least some of the network information objects, and computer readable code embodied therein, the computer readable code being capable of causing the one or more processors to:
obtain data for at least some of the number of network information objects;
correlate, according to the one or more correlation instructions, the at least some of the network information objects; and
obtain at least one correlated element for each of the at least some of the network information objects.

For a better understanding of the present invention, together with other and further needs thereof, reference is made to the accompanying drawings and detailed description and its scope will be pointed out in the appended claims.

### BRIEF DESCRIPTION OF THE SEVERAL VIEWS OF THE DRAWING

FIG. 1 is a schematic flowchart block diagram representation of a conventional system for providing analysis results to devices in a network;

FIG. 2 is a schematic flowchart block diagram representation of an embodiment of the system of this invention;

FIG. 3 is a schematic block diagram representation of an embodiment of the system of this invention; and

FIG. 4 is a schematic flowchart representation of an embodiment of the method of this invention.

### DETAILED DESCRIPTION OF THE INVENTION

Methods and systems that substantially reduce the burden of fulfilling network management request response details are presented hereinbelow.

“Metadata” as used herein refers to a description of other data.

“Objects,” when used in the context of a computer code or application, refer to objects such as those used in network management wherein each object has a name, attributes and, in some embodiments, a set of operation that can be performed on the object.

“Middleware” as used herein refers to software that mediate between two separate application programs, such as, for example, messaging services so that different applications can communicate.

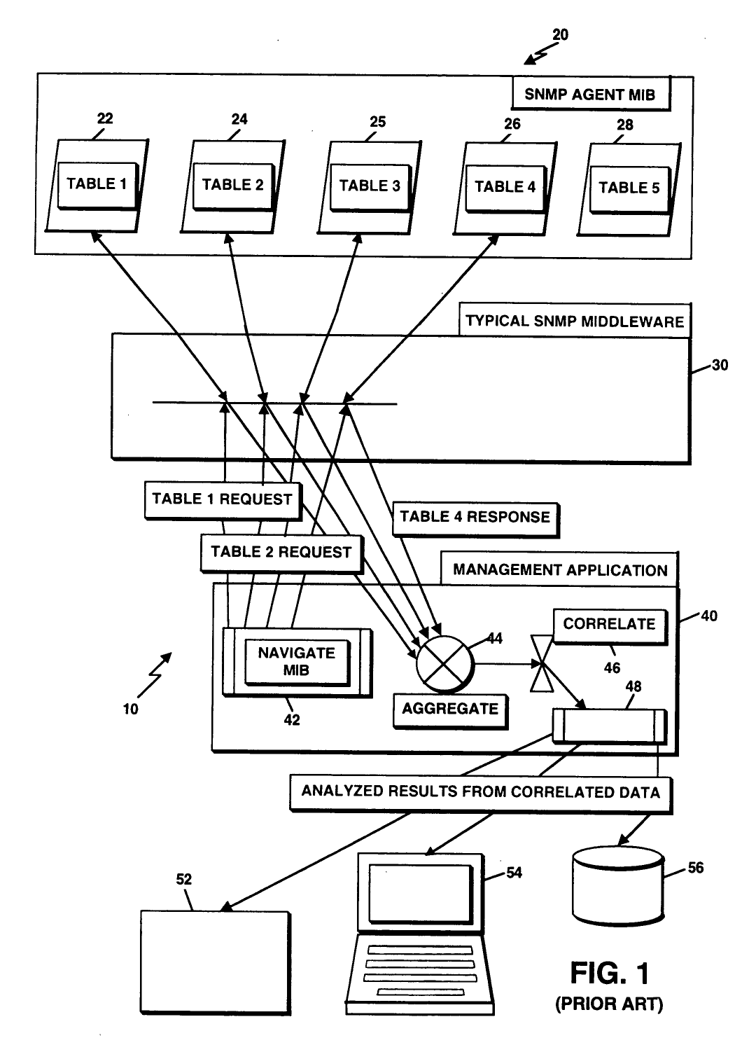

FIG. 1 shows a conventional system 10 for providing management analysis results to devices in a network. The conventional system 10 utilizes the Simple network management protocol (SNMP). The conventional system 10 includes a management information base (MIB) 20 with five tables of data 22, 24, 25, 26, 28, SNMP middleware 30, a management application (software) 40 including a component 42 that requests information from the MIB 20, a component 44 that aggregates the received information, a component 46 that correlates the aggregated information, and a component 48 that performs the management request and communicates with the network devices 52, 54, 56.

In order to illustrate the operation of the conventional system 10, the following example is provided. In an exemplary application, Table 1 corresponds to interfaces and Table 2 corresponds IP address in a host. Table 1 contains the interface description and is herein after referred to as interfaceTable. Table 2 contains the IP addresses and is herein after referred to as ipAddrTable. In one example, the tables contain the data as shown below.

InterfaceTable

| Index | interfDescr |
|---|---|
| 1 | atm |
| 2 | frame-relay |
| 3 | smds |

ipAddrTable

| index | interfaceIndex |
|---|---|
| a.b.c.d | 1 |
| m.n.o.p | 1 |
| i.j.k.l | 2 |
| p.q.r.s | 3 |

The above tables indicate that the interface 1 is of type atm and has two addresses a.b.c.d and m.n.o.p assigned to it, Interface 2 is of type frame-relay with a sole address i.j.k.l, while interface 3 is of type smds with address p.q.r.s.

During operation of the conventional system 10, if the management application requires the addresses of atm interfaces, the component 42 issues a request for information from the MIB 20. The component 44 that aggregates the received information would receive the data in the two tables detailed component 44 that aggregates the received information as two lists given below.

List1

IfDescr.1=atm
IfDescr.2=frame-relay
IfDescr.3=smds
   List2
IpAdEntIfIndex.a.b.c.d=1
IpAdEntIfIndex.m.n.o.p=1
IpAdEntIfIndex.i.j.k.1=2
IpAdEntIfIndex.p.q.r.s=3

The component 44 would have to include the operations of scanning through first list and gathering all the atm interface (right hand side) indexes by parsing the variable ID (left hand side). The component 44 would also have to include the operations of finding those entries in the second list where the interface indexes from the first list are present on the right hand side, finding the variable ID on the left hand side and parsing the found results to obtain the addresses.

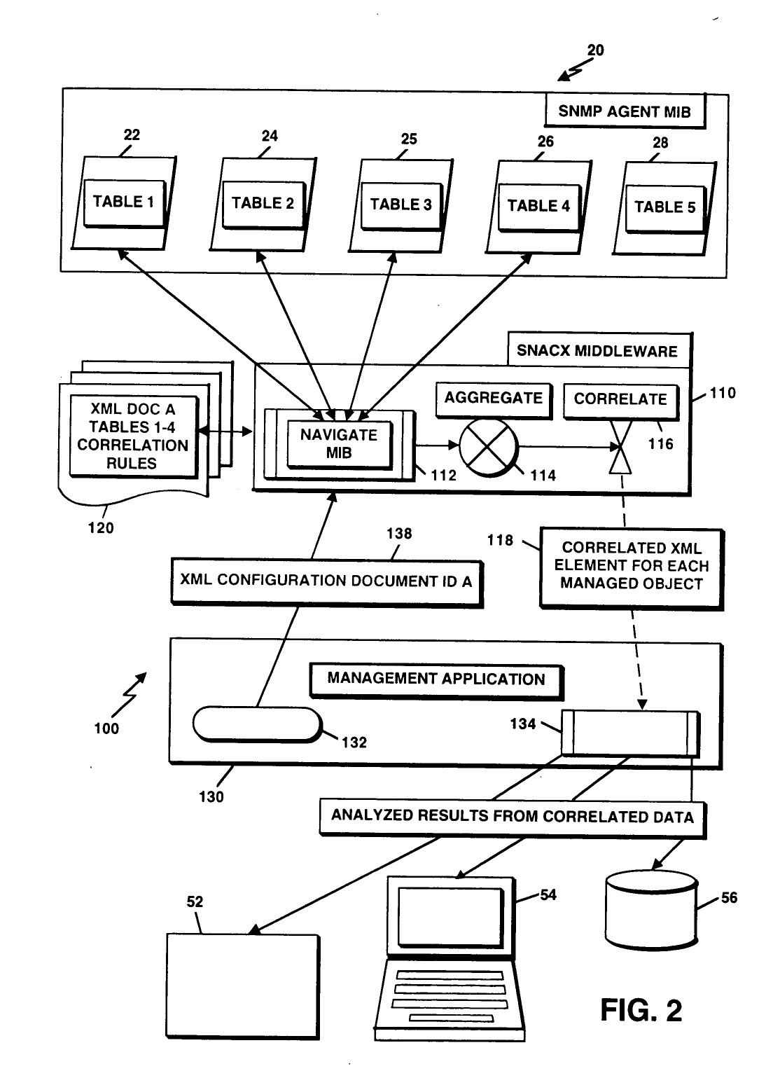

A flowchart/block diagram representation of an embodiment 100 of the system of this invention is shown in FIG. 2. Referring to FIG. 2, the embodiment 100 of the system of this invention, as shown, utilizes the Simple network management protocol (SNMP), but this is not a limitation of this invention. The embodiment 100 of the system of this invention shown in FIG. 2 includes a management information base (MIB) 20 with, for example but not a limitation of this invention, five tables of data 22, 24, 25, 26, 28, middleware of this invention 110 including a component 112 that requests information from the MIB 20, a component 114 that aggregates the received information, a component 116 that correlates the aggregated information, and a management application (software) 130 including a component 132 that initiates the request of information and a component 134 that performs the management request and communicates with the network devices 52, 54, 56. Also included in the embodiment 100 of the system of this invention shown in FIG. 2 are a description, stored in a computer usable medium 120, of a number of network information objects (in one embodiment, the objects correspond to Tables 22, 24, 25, 26, 28), where the description includes a logically descriptive name (such as “interface”) for each Table (network information object), and correlation instructions (rules), also stored in the computer usable medium 120, describing relationships between the network information objects, where the correlation instructions (rules) are expressed in terms of the description of the network information objects. The middleware of this invention 110 is capable of obtaining a correlated element 118 for each of the network information objects of interest and provide the correlated element 118 to the management application 130. In one embodiment, the description of the number of network information objects (Tables), the correlation instructions and the correlated element are generated in metadata. In one aspect, the metadata is expressed in a generalized markup language, such as, but not limited to, XML.

In order to illustrate the operation of the embodiment 100 of the system of this invention, the operation of the embodiment 100 for the sample Tables described above is detailed below.

The Tables (network information objects) are described as XML objects in the following form.

<Table name=“interface”>

<Variable name=“description” oid=“1.3.6.1.2.1.2.2.1.2 ” />

</Table>

<Table name=“address”>

<Variable name=“interfaceIndex” oid=“1.3.6.1.2.1.4.20.1.2 ”

/>

</Table>

The correlation instructions, described as XML objects, are shown below.

<Relationship relation=“containment”>

<Object container=“interface” containerField=“instance”

contained=“address” containedField=“interfaceIndex” />

<Condition operation=“equal” />

</Relationship>

The objects of interest are described using logical descriptive names. A one to many relationship between interfaces and addresses is indicated. The Relationship object states that an interface can contain addresses and the related instances of interfaces and addresses are arrived by locating the entries in both the tables an InterfaceDescription (interfDescr) having an index equal to the interfaceindex in the ipAddrTable Table. The middleware can then proceed to retrieve the same two tables as a conventional system would have retrieved. The middleware can also perform the correlation and produce the elements given below.

<interface instance=“1” description=“atm” >

<address instance=“a.b.c.d” interfaceIndex=“1” />
<address instance=“m.n.o.p” interfaceIndex=“1” />

</interface>

<interface instance=“2” description=“frame-relay” >

<address instance=“i.j.k.l” interfaceIndex=“2” />

</interface>

<interface instance=“3” description=“smds” >

<address instance=“p.q.r.sl” interfaceIndex=“3” />

</interface>

A management application interested in atm interfaces would scan the list of interfaces. When the management application finds the node with “atm” as description, the management application has all the addresses it needs in the same element as sub nodes, without searching further lists.

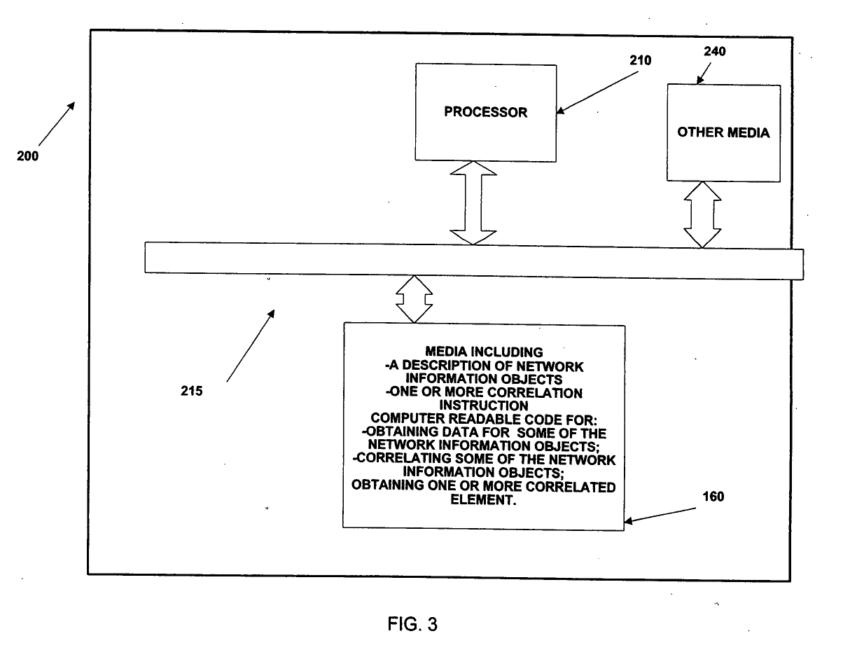

A block diagram representation depicting some of the hardware components of an embodiment 200 of the system of this invention is shown in FIG. 3. Referring to FIG. 3, the embodiment 200 of the system of this invention includes one or more processors 210, one or more computer readable media 260 and one or more other computer readable media 240 operatively connected to interconnection means 215. The one or more computer readable media 260 store a description of a number of network information objects, one or more correlation instructions describing one or more relationships between the network information objects, and have computer readable code embodied therein, the computer readable code capable of causing the one or more processors 210 to retrieve data for the network information objects from the tables in the MIB, correlate, according to the one or more correlation instructions, at least some of the network information objects, to obtain a correlated element for some of the network information objects, and to provide the correlated element to the management application.

The one or more other computer readable media 240 in the embodiment 200 of the system of this invention shown in FIG. 3 store at least one data structure including information resident in a database used by the computer readable code, where the information includes data for the network information objects.

It should be noted that the embodiment 200 of the system of this invention can be, but is not limited to, a distributed embodiment and that the one or more computer readable media 260 and/or one or more other computer readable media 240 can be, but are not limited to, several computer readable media at different locations. Similarly, the one or more processors 210 can be, but are not limited to, several processors at different locations. The interconnection means 215 can include, but are not limited to, a computer bus, a wired connection, electromagnetic carrier waves, an optical connection or a combination thereof.

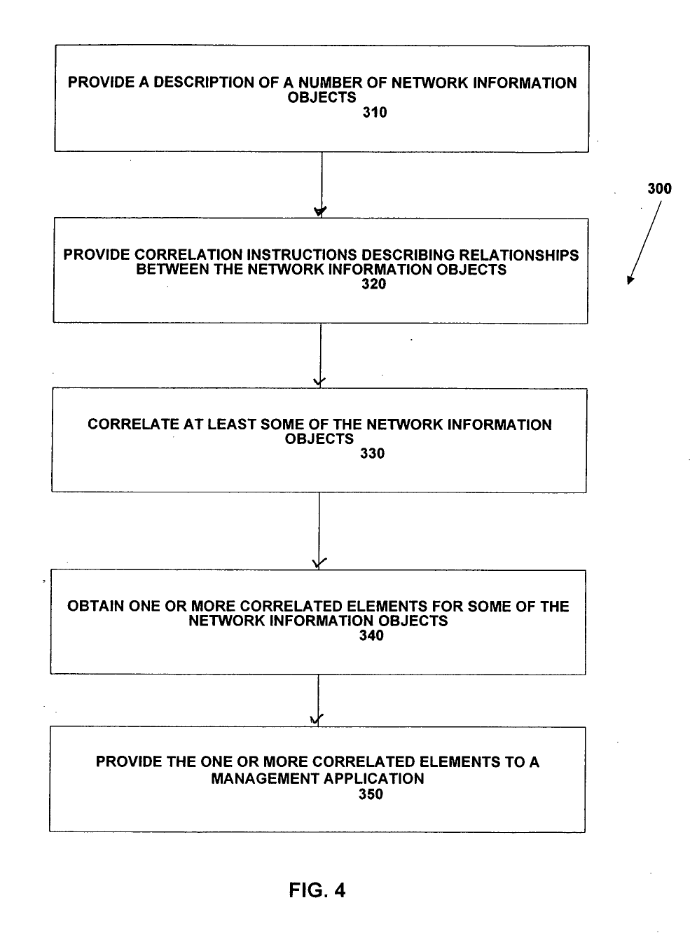

During operation of the embodiment 100 of the system of this invention, the description of the network information objects and the correlation instructions (rules) are provided to the middleware 110 (steps 310, 320, FIG. 4), data for some of the network information objects is retrieved from the tables (22, 24, 25, 26, 28) in the MIB 20 (step 330, FIG. 4), the retrieved network information objects are correlated (step 340, FIG. 4), correlated elements are obtained for the retrieved network information objects (step 350, FIG. 4), and the correlated elements are provided to the management application 130 (step 360, FIG. 4).

It should be noted that, although the invention has been described in terms of an embodiment utilizing a specific generalized markup language, XML, this is not a limitation of the invention and other generalized markup languages, sources of metadata, and other means of providing a logically descriptive name for each network information object and providing correlation rules are within the scope of this invention.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program (code) within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A method for managing networks, the method comprising the steps of:
providing a description of a plurality of network information objects, the description comprising a descriptive name for each network information object from the plurality of network information objects;
providing correlation instructions describing relationships between the plurality of network information objects, the correlation instructions being expressed in terms of the description of at least some of the plurality of network information objects;
obtaining data for the at least some of the plurality of network information objects;
correlating the at least some of the plurality of network information objects; and
obtaining at least one correlated element for each of the at least some of the plurality of network information objects.

2. The method of claim 1 where in the step of providing a description of the plurality of network information objects comprises the step of:
generating, in metadata, the description of the plurality of network information objects.

3. The method of claim 2 wherein the metadata is expressed in a generalized markup language.

4. The method of claim 1 where in the step of providing correlation instructions comprises the step of:
generating, in metadata, the correlation instructions.

5. The method of claim 1 further comprising the step of:
providing the at least one correlated element for each of the at least some of the plurality of network information objects to a management application;
whereby the management application manages the network.

6. A system comprising:
at least one processor;
at least one computer usable medium comprising:
a description, stored in said at least one computer usable medium, of a plurality of network information objects, the description comprising a descriptive name for each network information object from said plurality of network information objects;
at least one correlation instruction describing at least one relationship between said plurality of network information objects, said at least one correlation instruction being expressed in terms of said description of at least some of said plurality of network information objects;
computer readable code embodied therein, said computer readable code being capable of causing said at least one processor to:
obtain data for at least some of said plurality of network information objects;
correlate, according to said at least one correlation instruction, said at least some of said plurality of network information objects; and
obtain at least one correlated element for each of said at least some of said plurality of network information objects.

7. The system of claim 6 further comprising:
at least one other computer usable medium comprising:
at least one data structure including information resident in a database used by said computer readable code and including:
data for said plurality of network information objects.

8. The system of claim 6 wherein said at least one computer usable medium also comprises computer readable code capable of causing said at least one processor to:
generate, in metadata, said description of said plurality of network information objects.

9. The system of claim 8 wherein the metadata is expressed in a generalized markup language.

10. The system of claim 6 wherein said at least one computer usable medium also comprises computer readable code capable of causing said at least one processor to:
provide said at least one correlated element for each of said at least some of said plurality of network information objects to a management application.

11. A computer program product comprising:
a computer usable medium having computer readable code embodied therein, the computer readable code capable of causing at least one processor to:
receive a description, stored in said computer usable medium, of a plurality of network information objects, the description comprising a descriptive name for each network information object from said plurality of network information objects;
receive at least one correlation instruction describing at least one relationship between said plurality of network information objects, said at least one correlation instruction being expressed in terms of said description of at least some of said plurality of network information objects;
obtain data for at least some of a plurality of network information objects;
correlate, according to said at least one correlation instruction, said at least some of said plurality of network information objects; and
obtain at least one correlated element for each one of said at least some of said plurality of network information objects.

12. The computer program product of claim 10 wherein said computer readable code also capable of causing at least one processor to:
provide the at least one correlated element for each one of the at least some of the plurality of network information objects to a management application.

13. The computer program product of claim 10 wherein said description is expressed in metadata.

14. The computer program product of claim 13 wherein said metadata is expressed in a generalized markup language.

15. The computer program product of claim 10 wherein said at least one correlation instruction is expressed in metadata.

16. The computer program product of claim 15 wherein said metadata is expressed in a generalized markup language.
